(19) United States
(12) Patent Application Publication
(10) Pub. No.: US 2012/0257118 A1
(43) Pub. Date: Oct. 11, 2012

(54) IMAGE PROCESSING APPARATUS AND METHOD, RECORDING MEDIUM, AND PROGRAM

(75) Inventors: Hidenori Aotake, Tokyo (JP); Michio Miyano, Kanagawa (JP); Kenichi Ishida, Tokyo (JP)

(73) Assignee: SONY CORPORATION, Tokyo (JP)

(21) Appl. No.: 13/435,181

(22) Filed: Mar. 30, 2012

(30) Foreign Application Priority Data
Apr. 8, 2011 (JP) 2011-086308

(51) Int. Cl. H04N 5/44

(52) U.S. Cl. 348/725; 348/E05.096

(57) ABSTRACT

An image processing apparatus includes: a first conversion unit configured to convert a first type of command out of commands conforming to a first standard into a first command conforming to a second standard; a second conversion unit configured to convert a second type of command out of the commands conforming to the first standard into a command that conforms to the second standard and is different from the first command; and an output unit configured to output the first command and the second command.

### BACKGROUND

The present disclosure relates to an image processing apparatus and method, a recording medium, and a program, more particularly, to an image processing apparatus and method, a recording medium, and a program with which an inexpensive apparatus can be provided.

For example, Japanese Patent Application Laid-open No. 2010-246057 proposes a technique of connecting electronic apparatuses using a cable of an HDMI-CEC standard. Many television receivers that are used in standard homes are also structured to be connectable to the HDMI-CEC-standard cable.

On the other hand, a technique of connecting electronic apparatuses based on an RS232C standard is also known. For example, television receivers installed in hotel rooms are often controlled via a cable conforming to the RS232C standard from a set-top box or a signage controller.

However, because the RS232C standard has not prevailed that much in standard homes, many television receivers that are used in standard homes cannot be connected to the RS232C-standard cable.

### SUMMARY

In this regard, industrial television receivers used in hotels and the like have been specially produced as dedicated television receivers different from that for standard homes or have been produced by reconstructing the television receivers for standard homes.

As a result, industrial television receivers have often been expensive.

The present disclosure has been made in view of the circumstances as described above to enable an inexpensive apparatus to be provided.

According to an embodiment of the present disclosure, there is provided an image processing apparatus including a first conversion unit, a second conversion unit, and an output unit. The first conversion unit is configured to convert a first type of command out of commands conforming to a first standard into a first command conforming to a second standard. The second conversion unit is configured to convert a second type of command out of the commands conforming to the first standard into a command that conforms to the second standard and is different from the first command. The output unit is configured to output the first command and the second command.

The first standard may be RS232C, and the second standard may be HDMI-CEC.

The image processing apparatus may be a controller that controls a television receiver, and the output unit may output the first command and the second command to the television receiver.

The first command may be a command conforming to the HDMI-CEC, and the second command may be a vendor command of the HDMI-CEC.

In the embodiment of the present disclosure, the first conversion unit converts the first type of command out of the commands conforming to the first standard into a first command conforming to the second standard, the second conversion unit converts the second type of command out of the commands conforming to the first standard into a command that conforms to the second standard and is different from the first command, and the output unit outputs the first command and the second command.

An image processing method, recording medium, and program according to the embodiment of the present disclosure are a method, recording medium, and program that correspond to the image processing apparatus according to the embodiment of the present disclosure described above.

As described above, according to the embodiment of the present disclosure, an inexpensive apparatus can be provided.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a structure of a television system according to an embodiment of the present disclosure;

FIG. 2 is a flowchart for explaining processing of a conversion adapter;

FIG. 3 is a diagram showing an example of a command conversion; and

FIG. 4 is a flowchart for explaining an operation of a television receiver.

### DETAILED DESCRIPTION OF EMBODIMENTS

Hereinafter, an embodiment of the present disclosure will be described with reference to the drawings. It should be noted that the descriptions will be given in the following order.
1. Explanation of HDMI-CEC and RS232C
2. Structure of television system
3. Processing of conversion adapter
4. Operation of television receiver
5. Application to program of present disclosure
6. Others

### [Explanation of HDMI-CEC and RS232C]

HDMI-CEC (High Definition Multimedia Interface-Consumer Electronics Control) has prevailed as a digital interface for transmitting a signal of an image constituted of a moving image or a still image and a baseband signal including a signal of an audio accompanying the image at high speed. The HDMI-CEC standard is a standard that is arranged for AV (Audio Visual) apparatuses and obtained by adding an audio transmission function and a copyright protection function to DVI (Digital Visual Interface) as a connection standard for a PC (Personal Computer) and a display.

It should be noted that the HDMI-CEC standard is sometimes simply referred to as HDMI standard but will be referred to as HDMI-CEC standard in this specification.

There are 3 types of apparatuses that are connected via an HDMI-CEC cable (hereinafter, referred to as HDMI apparatus). The 3 types are an HDMI source, an HDMI sink, and an HDMI repeater.

The HDMI source includes an output terminal that outputs image and audio signals via the HDMI-CEC cable, and the HDMI sink includes an input terminal to which the image and audio signals are input via the HDMI-CEC cable. The HDMI repeater includes one or more input terminals and one or more output terminals and relays the HDMI source and the HDMI sink while behaving as both the HDMI source and the HDMI sink.

HDMI-CEC includes a TMDS (Transition Minimized Differential Signaling) channel as a signal channel for unidirectionally transmitting image and audio baseband signals from the HDMI source to the HDMI sink via a requisite HDMI repeater. HDMI-CEC also includes a CEO (Consumer Electronics Control) line as a control channel for bidirectionally transmitting commands (i.e., messages) used for controlling the HDMI source, the requisite HDMI repeater, and the HDMI sink, and other channels.

Specifically, in HDMI-CEC, the TMDS channel is adopted in a physical layer, whereas the CEC line is adopted for connections of a control system of the overall apparatus that is connected by the HDMI-CEC cable.

In addition, in HDMI-CEC, EDID (Extended Display Identification Data) is adopted for an inter-apparatus authentication.

In other words, a DDC/EDID system of VESA (Video Electronics Standard Association) is adopted for an authentication between HDMI-CEC apparatuses.

A DDC (Display Data Channel) is used for the HDMI source to read out EDID (Enhanced Extended Display Identification Data) from the HDMI sink and the HDMI repeater.

In other words, the HDMI sink and the HDMI repeater each include an EDID ROM (Read Only Memory) that stores EDID as information on own settings (configuration) and capability. The HDMI source reads out the EDID stored in the EDID ROMs of the HDMI sink and the HDMI repeater via the DDC and recognizes the settings and capabilities of the HDMI sink and the HDMI repeater based on the EDID.

An apparatus conforming to the HDMI-CEC standard will be referred to as HDMI-CEC apparatus. The HDMI-CEC apparatus is allocated with a unique physical address.

On the other hand, the RS232C (Recommended Standard 232 version C) standard is a standard for serial interfaces for connecting personal computers and peripheral apparatuses.

### [Structure of Television System]

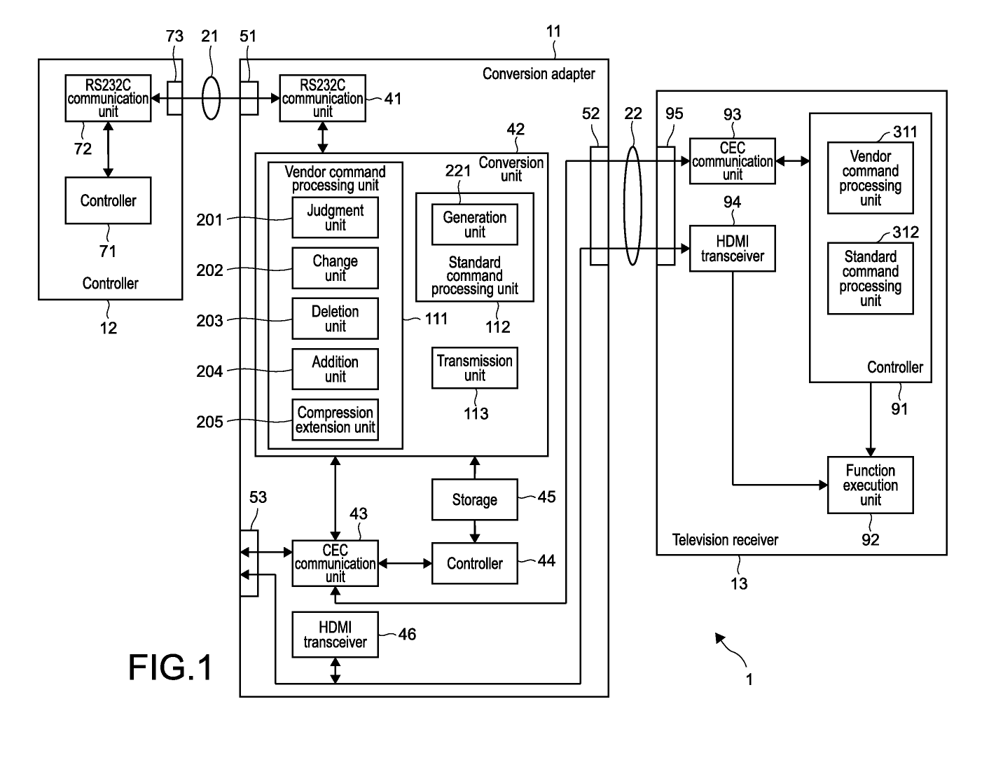

FIG. 1 is a block diagram showing a structure of a television system 1 according to an embodiment of the present disclosure. It should be noted that FIG. 1 mainly shows only structures related to the present disclosure.

The television system 1 is constituted of a conversion adapter 11, a controller 12, and a television receiver 13. The conversion adapter 11 and the television receiver 13 are the HDMI-CEC apparatuses. A user operates the controller 12 to control the television receiver 13 and display an image of a predetermined channel.

It should be noted that information transmitted in this embodiment is mainly a video signal and an audio signal accompanying it, but for brevity of descriptions, only processing on video signals will be described below. However, audio signals are of course processed in the same manner.

The controller 12 and the conversion adapter 11 are connected by an RS232C-standard cable 21, and the conversion adapter 11 and the television receiver 13 are connected by an HDMI-CEC cable 22. The conversion adapter 11 is structured as a so-called conversion box that is provided on a back surface of the television receiver 13, for example.

The controller 12 is structured as a signage controller and includes a controller 71, an RS232C communication unit 72, and a terminal 73.

The controller 71 outputs a signal corresponding to a user input to the RS232C communication unit 72. The RS232C communication unit 72 establishes communication that is based on the RS232C standard with the conversion adapter 11 via the cable 21. The terminal 73 is a terminal to which the RS232C-standard cable 21 is connected.

The television receiver 13 includes a controller 91, a function execution unit 92, a CEC communication unit 93, an HDMI transceiver 94, and a terminal 95.

In addition to control of the units in response to instructions from the user, the controller 91 receives a command from the CEC communication unit 93 and controls the function execution unit 92 to execute corresponding processing. The controller 91 includes a vendor command processing unit 311 and a standard command processing unit 312. The vendor command processing unit 311 processes a vendor command out of commands from the CEC communication unit 93. The standard command processing unit 312 processes a standard command out of the commands from the CEC communication unit 93. The vendor command processing unit 311 and the standard command processing unit 312 are each constituted of a microcomputer in this embodiment, but the two of them may be constituted of a single microcomputer.

It should be noted that the controller 91 also includes a function for controlling other apparatuses via the CEC communication unit 93 and the cable 22.

The function execution unit 92 receives, displays, and outputs video signals of a predetermined channel in response to an instruction from the controller 91. The function execution unit 92 also receives, displays, and outputs video signals received by the HDMI transceiver 94.

The HDMI transceiver 94 receives video signals supplied from the conversion adapter 11 via the cable 22 and supplies them to the function execution unit 92. The CEC communication unit 93 receives a command supplied from the conversion adapter 11 via a CEC line of the cable 22 and outputs a corresponding signal to the controller 91. The terminal 95 is a terminal to which the HDMI-CEC cable 22 is connected.

The conversion adapter 11 as an image processing apparatus includes an RS232C communication unit 41, a conversion unit 42, a CEC communication unit 43, a controller 44, a storage 45, and an HDMI transceiver 46. The conversion adapter 11 also includes terminals 51, 52, and 53. The terminal 51 is a terminal to which an RS232C-standard cable is connected, and the terminals 52 and 53 are terminals to which HDMI-CEC standard cables are connected.

The RS232C communication unit 41 establishes communication that is based on the RS232C standard with the RS232C communication unit 72 of the controller 12 via the cable 21.

The conversion unit 42 converts a command supplied from the RS232C communication unit 41, which is based on a protocol of the RS232C standard, into a command that is based on a protocol of the HDMI-CEC standard and outputs it to the CEC communication unit 43. The conversion unit 42 also converts a command input from the CEC communication unit 43, which is based on the HDMI-CEC standard, into a command that is based on the RS232C standard and outputs it to the RS232C communication unit 41. The RS232C communication unit 41 outputs the command to the RS232C communication unit 72 of the controller 12 via the cable 21.

The conversion unit 42 includes functional blocks of a vendor command processing unit 111, a standard command processing unit 112, and a transmission unit 113 for executing various types of processing according to programs stored in the storage 45.

The vendor command processing unit 111 executes processing of a vendor command out of commands of the HDMI-CEC standard. The vendor command processing unit 111 includes functional blocks of a judgment unit 201, a change unit 202, a deletion unit 203, an addition unit 204, and a compression extension unit 205. The functional blocks are realized according to programs stored in the storage 45.

The judgment unit 201 carries out various types of judgment processing. The change unit 202 executes processing of changing a content of a predetermined field of a command. The deletion unit 203 executes processing of deleting a predetermined field of a command. The addition unit 204 executes processing of adding a predetermined field of a command. The compression extension unit 205 executes compression extension processing of data of a predetermined field of a command.

The standard command processing unit 112 executes processing of a standard command out of the commands of the HDMI-CEC standard. The standard command processing unit 112 includes a generation unit 221. The generation unit 221 generates a standard command. The transmission unit 113 outputs a command generated by the vendor command processing unit 111 or the standard command processing unit 112 to the CEC communication unit 43.

The CEC communication unit 43 outputs a command supplied from the conversion unit 42 to the CEC communication unit 93 of the television receiver 13 via the cable 22 in addition to the controller 44. The CEC communication unit 43 also communicates with the CEC communication unit 93 of the television receiver 13 via the cable 22. The controller 44 is constituted of, for example, a microprocessor and carries out various types of control according to programs stored in the storage 45.

The HDMI transceiver 46 exchanges video signals with the HDMI transceiver 94 of the television receiver 13 via the cable 22.

It should be noted that when another apparatus is connected to the terminal 53 via an HDMI-CEC-standard cable, commands and video signals are also exchanged with that apparatus.

### [Processing of Conversion Adapter]

Next, processing of the conversion adapter 11 will be described.

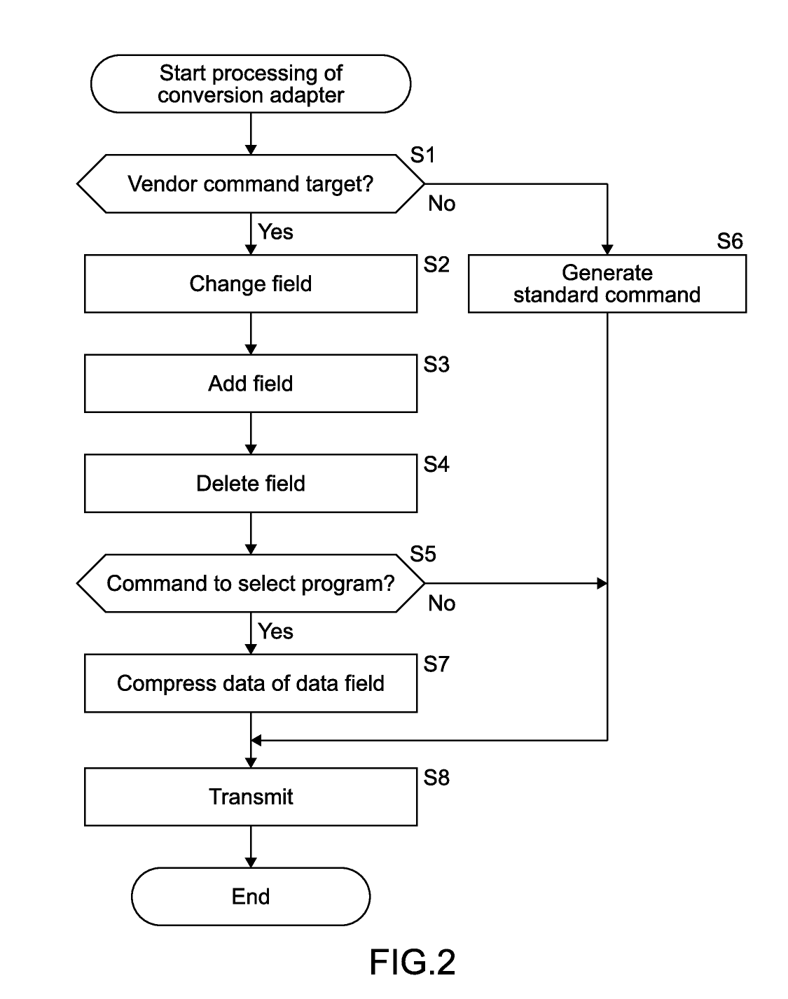

FIG. 2 is a flowchart for explaining the processing of the conversion adapter 11. The processing is started when a command is input from the controller 12.

When the user controls the controller 12 and inputs a predetermined instruction, the controller 71 generates a command corresponding to the instruction and outputs it to the RS232C communication unit 72. The RS232C communication unit 72 converts the input command into a command conforming to the RS232C standard. The command is input to the RS232C communication unit 41 of the conversion adapter 11 via the cable 21. The RS232C communication unit 41 supplies the command conforming to the RS232C standard to the conversion unit 42.

In the conversion unit 42, the judgment unit 201 of the vendor command processing unit 111 judges whether the command input from the RS232C communication unit 41 is a vendor command target in Step S1. The input RS232C command is converted into a standard command or vendor command conforming to the HDMI-CEC standard. The vendor command is a command that can be set arbitrarily by each vendor (e.g., manufacturer of apparatus that uses command) under the condition that it conforms to the HDMI-CEC standard.

Which of the standard command and the vendor command the RS232C command is converted into is determined in advance. In the case of this embodiment, the command that is converted into a standard command is a first type of command subsequent to RS232C. Specifically, a control command for turning on/off power, an enquiry command for confirming power state, and a volume up/down command for turning up/down a volume are each converted into a standard command. A second type of command is converted into a vendor command.

The control command for turning on power is transmitted when the television receiver 13 is in a sleep state. When the television receiver 13 is in the sleep state, a small microcomputer constituting the standard command processing unit 312 is not operating in the television receiver 13. In other words, when the television receiver 13 is in the sleep state, the vendor command processing unit 311 is not operating. In this regard the RS232C control command for turning on power is converted into a standard command.

The control command for turning off power is transmitted when the television receiver 13 is in an operation state. Therefore, although the control command for turning off power can be converted into a vendor command, the control command for turning off power is converted into a standard command along with the control command for turning on power. That way, consistency is obtained, and processing becomes simple.

The enquiry command for confirming power state is sometimes transmitted when the television receiver 13 is in the sleep state. In this regard, the RS232C enquiry command for confirming power state is converted into a standard command.

The volume up/down command as a vendor command for turning up/down a volume becomes as long as, for example, 12 bytes. In contrast, a standard command is as long as 3 bytes. The shorter command can complete its transmission in a shorter time and thus can more-quickly change a volume that much. In this regard, in this embodiment, the volume up/down command for turning up/down a volume is converted into a standard command.

Furthermore, in this embodiment, the volume up/down command for turning up/down a volume is transmitted only once. After that, a new command is not transmitted while the instruction to turn up/down a volume is continuing. When the instruction to turn up/down a volume is stopped, a command to release the up/down button is transmitted. In the television receiver 13, upon receiving the up/down command once, up/down is continuously repeated, and when the release command is received, the up/down processing is stopped. As a result, more-quick processing becomes possible.

When the RS232C command input in Step S1 is judged to be a vendor command target, the change unit 202 changes a field in Step S2. In Step S3, the addition unit 204 adds a field. In Step S4, the deletion unit 203 deletes a field. In other words, when it is necessary to change a field of the RS232C command for converting the RS232C command into a vendor command, change processing is executed. Similarly, when it is necessary to add a new field for converting the RS232C command into a vendor command, addition processing is executed, and when it is necessary to delete a field of the RS232C command, deletion processing is executed. These processing are executed when necessary.

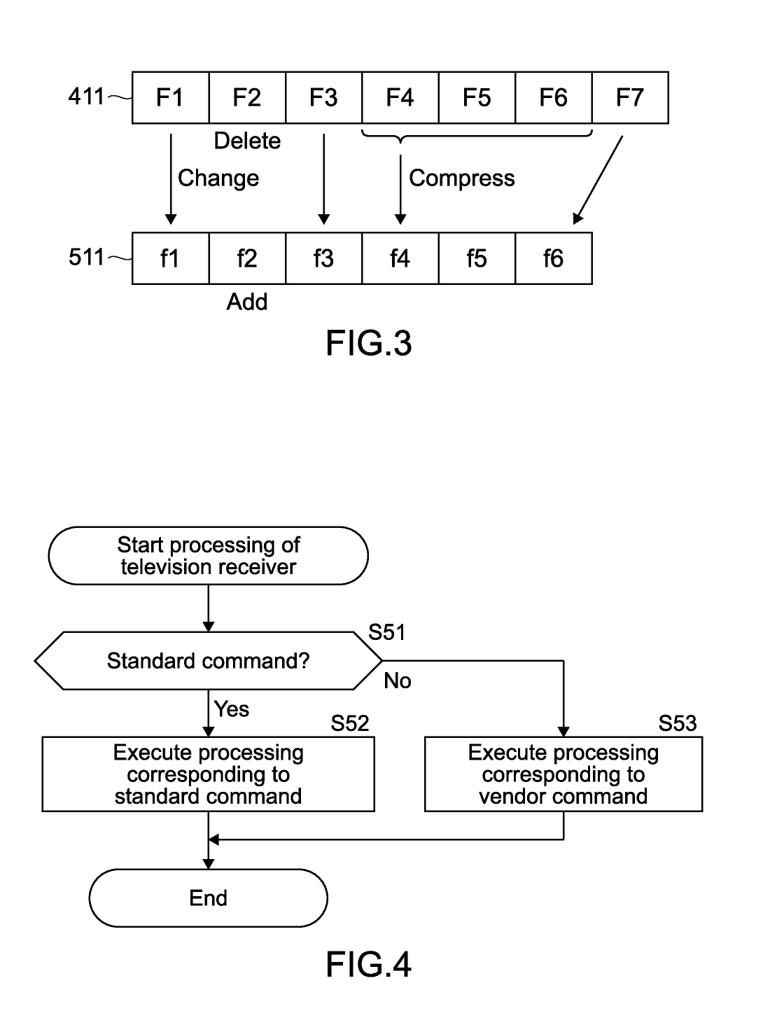

FIG. 3 is a diagram showing an example of a command conversion. In FIG. 3, the command shown on the upper side is an RS232C command 411, and the command shown on the lower side is a vendor command 511.

A content of a first field F1 of the RS232C command 411 is changed to a first field f1 of the vendor command 511. A second field F2 of the RS232C command 411 is not used in the vendor command 511, so the second field F2 is deleted.

A third field F3 and seventh field F7 of the RS232C command 411 are used as they are as a third field f3 and sixth field f6 of the vendor command 511. Such processing is also executed by the change unit 202. Fourth to sixth fields F4 to F6 of the RS232C command 411 are compressed to be fourth and fifth fields f4 and f5 of the vendor command 511.

In Step S5, the judgment unit 201 judges whether the command is a command to select a program. When the input RS232C command is a command to select a program, the compression extension unit 205 compresses data of the data field in Step S7.

Specifically, the length of the RS232C command to select a program is longer than that of the vendor command. In this regard, the RS232C command to select a program is compressed in its length to be a vendor command.

When it is judged in Step S5 that the input RS232C command is not a command to select a program, the compression processing of Step S7 is skipped, and the processing advances to Step S8.

When it is judged in Step S1 that the input RS232C command is not a vendor command target, the generation unit 221 of the standard command processing unit 112 generates a standard command in Step S6. In other words, a standard command conforming to the HDMI-CEC standard, that corresponds to the input RS232C command, is generated.

When it is judged that the input RS232C command is not a command to select a program in Step S5 after Steps S6 and S7, the process of Step S8 is executed. In Step S8, the transmission unit 113 transmits the command.

Specifically, a standard command or a vendor command is transmitted from the CEC communication unit 43 to the CEC communication unit 93 of the television receiver 13 via the cable 22. The CEC communication unit 93 supplies the acquired command to the controller 91.

### [Operation of Television Receiver]

Next, referring to FIG. 4, an operation of the television receiver that has received a command as described above will be described.

FIG. 4 is a flowchart for explaining the operation of the television receiver 13. In Step S51, the standard command processing unit 312 of the controller 91 of the television receiver 13 judges whether a command input via the cable 22 is a standard command. When the command supplied from the conversion adapter 11 is a standard command, the standard command processing unit 312 executes processing corresponding to the standard command in Step S52. Specifically, the standard command processing unit 312 controls the function execution unit 92 to execute the processing corresponding to the standard command based on the input standard command.

On the other hand, when it is judged that the command input in Step S51 is not a standard command, the vendor command processing unit 311 acquires a command and executes processing corresponding to a vendor command. Specifically, the vendor command processing unit 311 controls the function execution unit 92 to execute the processing corresponding to the vendor command based on the input vendor command.

As described above, in this embodiment, the terminal to which the RS232C-standard cable is connected is not provided in the television receiver 13 as a control target, but the terminal to which the HDMI-CEC-standard cable is connected is. As a result, television receivers used in standard homes can be used as they are in hotels and the like, and since television receivers do not need to be specially installed or reconstructed, low costs can be realized.

It should be noted that the control target of the present disclosure is not limited to a television receiver and is also applicable to a case of controlling a signage display or other various electronic apparatuses.

### [Application to Program of Present Disclosure]

The series of processing described above can be executed either by hardware or software.

When the series of processing are executed by software, programs constituting the software are installed in, from a network or a recording medium, a computer into which the programs are incorporated in dedicated hardware or a general-purpose personal computer that is capable of executing various functions by installing various programs.

It should be noted that in the specification, the steps of describing a program to be recorded onto a recording medium include processes that are executed in parallel or independently even when processed in time series or not processed in time series.

Further, the embodiment of the present disclosure is not limited to that described above and can be variously modified without departing from the gist of the present disclosure.

### [Others]

The present disclosure may also take the following structures.

(1) An image processing apparatus, including:

a first conversion unit configured to convert a first type of command out of commands conforming to a first standard into a first command conforming to a second standard;

a second conversion unit configured to convert a second type of command out of the commands conforming to the first standard into a command that conforms to the second standard and is different from the first command; and

an output unit configured to output the first command and the second command.

(2) The image processing apparatus according to (1) above,

in which the first standard is RS232C, and the second standard is HDMI-CEC.

(3) The image processing apparatus according to (1) or (2) above,

in which the image processing apparatus is a controller that controls a television receiver, and

in which the output unit outputs the first command and the second command to the television receiver.

(4) The image processing apparatus according to (2) above,

in which the first command is a command conforming to the HDMI-CEC, and

in which the second command is a vendor command of the HDMI-CEC.

(5) An image processing method, including:

converting a first type of command out of commands conforming to a first standard into a first command conforming to a second standard;

converting a second type of command out of the commands conforming to the first standard into a command that conforms to the second standard and is different from the first command; and

outputting the first command and the second command.

(6) A computer-readable recording medium that is recorded with a program that causes a computer to execute the steps of:

converting a first type of command out of commands conforming to a first standard into a first command conforming to a second standard;

converting a second type of command out of the commands conforming to the first standard into a command that conforms to the second standard and is different from the first command; and

outputting the first command and the second command.

(7) A program that causes a computer to execute the steps of:

converting a first type of command out of commands conforming to a first standard into a first command conforming to a second standard;

converting a second type of command out of the commands conforming to the first standard into a command that conforms to the second standard and is different from the first command; and

outputting the first command and the second command.

The present disclosure contains subject matter related to that disclosed in Japanese Priority Patent Application JP 2011-086308 filed in the Japan Patent Office on Apr. 8, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
a first conversion unit configured to convert a first type of command out of commands conforming to a first standard into a first command conforming to a second standard;
a second conversion unit configured to convert a second type of command out of the commands conforming to the first standard into a command that conforms to the second standard and is different from the first command; and
an output unit configured to output the first command and the second command.

2. The image processing apparatus according to claim 1,
wherein the first standard is RS232C, and the second standard is HDMI-CEC.

3. The image processing apparatus according to claim 2,
wherein the image processing apparatus is a controller that controls a television receiver, and
wherein the output unit outputs the first command and the second command to the television receiver.

4. The image processing apparatus according to claim 3,
wherein the first command is a command conforming to the HDMI-CEC, and
wherein the second command is a vendor command of the HDMI-CEC.

5. An image processing method, comprising:
converting a first type of command out of commands conforming to a first standard into a first command conforming to a second standard;
converting a second type of command out of the commands conforming to the first standard into a command that conforms to the second standard and is different from the first command; and
outputting the first command and the second command.

6. A computer-readable recording medium that is recorded with a program that causes a computer to execute the steps of:
converting a first type of command out of commands conforming to a first standard into a first command conforming to a second standard;
converting a second type of command out of the commands conforming to the first standard into a command that conforms to the second standard and is different from the first command; and
outputting the first command and the second command.

7. A program that causes a computer to execute the steps of:
converting a first type of command out of commands conforming to a first standard into a first command conforming to a second standard;
converting a second type of command out of the commands conforming to the first standard into a command that conforms to the second standard and is different from the first command; and
outputting the first command and the second command.
